(19) United States
(12) Patent Application Publication
(10) Pub. No.: US 2011/0192801 A1
(43) Pub. Date: Aug. 11, 2011

(54) Method for Treating a Liquid by Flotation Induced by Floating Particles

(75) Inventors: Jean-Paul Jeanmarie, Maurecourt (FR); Philippe Marteil, Vigny (FR); Philippe Breant, Neauphle le Chateau (FR)

(73) Assignee: VEOLIA WATER SOLUTIONS & TECHNOLOGIES SUPPORT, Saint-Maurice Cedex (FR)

(21) Appl. No.: 13/056,435

(22) PCT Filed: Jul. 27, 2009
(86) PCT No.: PCT/EP09/59680

§ 371 Date: Mar. 10, 2011

(30) Foreign Application Priority Data
Jul. 29, 2008 (FR) 0855224

(51) Int. Cl. C02F 1/24

(52) U.S. Cl. 210/704

(57) ABSTRACT

A method or process for removing suspended solids from water. The method entails utilizing floating particles that include a flocculant material secured or coated to the floating particles. The floating particles are directed into a lower portion of a treatment zone and as the floating particles with the attached flocculant material move upwardly through the water, suspended solids attach or agglomerate on the floating particles. Once at the surface level of the water being treated, the floating particles can be removed and a cleaning process can be implemented where the suspended solids attached or agglomerated around the floating particles can be removed and the cleaned floating particles can be recycled and used for further water treatment.

### FIELD OF THE INVENTION

The field of the invention is that of the treatment of water in order to treat it or make it drinkable. The invention more particularly concerns the flotation treatment of water containing dissolved matter and/or matter in suspension.

### PRIOR ART

Contaminated liquids or water may contain suspended matter (particles, algae, bacteria etc) and dissolved matter (organic matter, micropollutants etc). In the prior art, there are several techniques for treating suspended matter, aimed at diminishing the level of these contaminants.

These techniques include decantation and flotation.

Decantation is a process of separation that applies to particles whose density is greater than that of the liquid which contains them while flotation is a method of separation which applies to particles whose density is lower than that of the liquid that contains them.

The treatment of water by flotation has many advantages as compared with treatment by decantation.

A first advantage is that the speed of treatment of water by flotation is greater than that of treatment by classic decantation.

Another advantage is that treatment by flotation eliminates algae more efficiently than does by decantation for a greater flow of water to be treated.

The bacteriological quality of water treated by flotation is greater than that obtained by decantation. Bacteriological quality, for its part, is related to the presence of microorganisms (bacteria, viruses, parasites). Thus, treatment by flotation eliminates microorganisms (cryptosporidia, giardia) more efficiently than does treatment by decantation.

Furthermore, another advantage of treatment by flotation is related to the fact that it reduces the volumes of sludge produced.

Among the flotation processes we may distinguish:
natural flotation where the difference in density between the matter in suspension and the water that contains it is naturally sufficient to enable their separation (the material floats to the surface of the water);
assisted flotation in which air bubbles are insufflated into the mass of liquid to improve the separation of the naturally floatable particles;
provoked flotation where the density of the matter in suspension is greater at the outset than that of the water containing it and is artificially reduced through gas bubbles. Indeed, certain solid or liquid particles may unite with gas bubbles to form “particle-bubble” bonds that are less dense than the water containing them.

Dissolved Air Flotation (DAF) is a process of provoked flotation that uses very fine bubbles or microbubbles with diameters of 40 to 70 microns. It generally comprises an association of different steps:
coagulation in order to neutralize the surface charges of the colloids and the absorption of the dissolved matter;
flocculation using flocculent polymer material enabling the agglomeration of the particles;
an injection of pressurized water enabling the microbubbles and the flocculated water to be brought into contact;
separation enabling the separation of the floc and of the clarified liquid;
collection of the clarified liquid;
collection of the floated “sludge”.

The DAF technique conventionally applies to good-quality, weakly mineralized water, to cold water lightly charged with suspended matter and especially to algae-rich reservoir water. This is a time-tested technique and is being constantly improved.

Among numerous improvements that have been made, we may cite:
DAFF (Dissolved Air Flotation/Filtration), which combines the DAF technique with filtration on granular material;
Ozoflotation, a technique developed by the Veolia group that uses ozonated air bubbles. The ozone is advantageously for used for disinfection (i.e. the destruction of the microorganisms), the elimination of smells, chemical substances and other pollutants (iron, manganese, pesticides) present in the water to be treated;
turbulent flotation (U.S. Pat. No. 5,516,433) which implements flow control and distribution elements at the base of the flotation zone to obtain a stable hydraulic regime.

However, despite these different improvements, the technology of flotation treatment continues to have a certain number of drawbacks.

The DAFF, ozofloatation and turbulent flotation methods have six drawbacks in common:
the speed of flotation is limited by the fine size of the bubbles;
the efficiency with which particles and coagulated matter are eliminated does not directly give the quality of the water required at exit from the line;
the complexity of the process which calls for a great deal of mechanical inputs (air saturator, recirculation pump, scraper etc);
the cost of the pressurization needed to produce recirculated return water is estimated at 40% of the operating costs;
their limited application to good-quality, weakly mineralized water resources, to cold water lightly charged with suspended matter and especially to algae-rich reservoir water
a non-negligible part of the polymer of the flocculent polymer material injected into the water does not take part in the formation of floc and remains dissolved in the water, thus prompting an acceleration of the clogging of filters placed downstream.

Furthermore, the introduction of air is a major drawback limiting the speed of filtration in structures coupled with a DAFF type filter. Indeed, an excessive speed soon leads to a gas embolism in the associated filter and even when the filtration is separate from the flotation in a second water pre-treatment step, a gas embolism is to be feared.

A part of these drawbacks is eliminated by the use of flotation techniques induced by floating particles. Such a method is described in the U.S. Pat. No. 6,890,431 B1 which provides for the use of solid floating particles in a flotation process and a recirculation of said particles in the flotation system after washing.

More specifically, U.S. Pat. No. 6,890,431 B1 discloses a method and a system for the clarification of fluids, the installation in question comprising:
a mixing chamber to mix the fluid with a coagulant;
a flocculation chamber communicating with the mixing chamber in which a flocculent reagent and a floating medium is mixed with the fluid-coagulant mixture obtained in the mixing chamber;
a floating chamber communicating with the flocculation chamber where a sludge including the floating medium associated with the part of the suspended matter to be eliminated is separated from the clarified liquid;
a unit for rehabilitating the floating medium, communicating with the floating chamber and with the flocculation chamber, within which unit the floating medium is washed of the suspended matter associated with it;
a recycling line to recycle the floating medium washed in the flocculation chamber.

However, one drawback of this type of technique lies in the fact that a part of the flocculent material remains dissolved in water and is liable to clog the filtration structures positioned downstream. Furthermore, the cost of this lost polymer increases the cost of implementing such a technique.

### GOALS OF THE INVENTION

It is a goal of the invention to improve a prior art method of this kind for treating water by flotation using floating particles.

The invention is aimed especially at proposing a water-treatment process that can have greater treatment efficiency.

The invention is also aimed at proposing a treatment method and a device which, if need be, make it easier to target the pollution to be combated.

### SUMMARY OF THE INVENTION

These different goals are achieved by means of the invention which pertains to a method for treating a liquid by flotation induced by floating particles comprising a step of mixing in which said floating particles are added to said liquid, a floating step in which said floating particles rise to the surface of the liquid and a step for separating said floating particles that have thus risen to the surface of the treated liquid,

which method is characterized in that at least certain of said floating particles have at least one flocculent polymer material attached to all or part of their surface, and which method does not include any step for adding gases or any step for adding a free flocculent material unattached to said particles.

According to such a technique, the flotation is done not by means of air bubbles but by means of solid floating particles. It will be noted that in the present description, the term “floating particles” is understood to designate particles having a real specific gravity of less than 1.

According to the invention, the floating particles also serve as a support for a flocculent polymer material.

The particles thus coated with flocculent polymer material will be prepared preliminarily.

This advantageously makes it possible to overcome the need to use any free flocculent agent dispersed in the liquid to be treated or being treated. This also reduces the quantity of flocculent needed to implement the method and therefore to reduce its cost.

Another advantage provided by the invention is that when the method is followed by a step for granular filtration or membrane filtration on one or more filtration structures, the absence of residual free flocculent reagent in the liquid entering these structures diminishes the speed at which these structures get clogged.

Preferably, said flocculent polymer material is an ionic polymer. As an overall preference, the material is a weak cationic or anionic polymer.

According to one interesting variant of the invention, at least one material other than said flocculent polymer material is also attached to said floating particles. It could be especially an adsorbent material such as activated carbon powder and/or a material having chemical or biological groupings dedicated to the elimination of certain specific pollutants of said liquid to be treated.

It can be noted that, in another variant which is possibly complementary to the method described in the previous section, this material which is other than the polymer material, could also be added to the liquid in free form, i.e. a form where it is not attached to the floating particles. This other material could be recycled as the case may be.

In the variant in which at least one material other than said flocculent polymer material is also attached to said floating particles, said chemical groupings and biological molecules could be determined as a function of the nature of the liquid to be treated and the nature of the targeted pollution or pollutions to be reduced in this liquid.

Said chemical groupings are preferably chosen from the group consisting of hydroxyl, aldehyde, carbinyl, carboxyl, amino, amido, sulfhydryl, ester, phosphor, methyl and phenyl.

Said biological molecules for their part will be preferably chosen from the group constituted by polypeptides and nucleic acids.

The floating particles used could be made out of a polymer material preferably chosen from the group consisting of polystyrenes, polyurethanes, polyethylenes and polyamides. Preferably, said floating particles will be constituted by polystyrene beads having a diameter of 100 to 1500 μm.

They could also be made out of a non-polymer material having a relative specific gravity of over 1 and preferably chosen in the group formed by glass, ceramics and metals but made in a hollow form demarcating a closed volume containing air in such a way that their relative specific gravity is below 1.

When the material constituting the particles is hydrophobic, the flocculent is hydrophobic, the flocculent polymer material will be preferably hydrophilic so as to make the floating particles themselves hydrophilic.

According to one variant, said flocculent polymer and/or said other material will take the form of a coating around said floating particles. The term “coating” is understood to mean a cooperation that does not bring into play any covalent bond between the flocculent polymer material and/or said other material on the one hand, and the material constituting said floating particles.

According to another variant, which can be obtained when said particles are made out of a synthetic material, said flocculent polymer material and/or said other material is grafted onto said synthetic material constituting said floating particles. In this case, a chemical reaction will be implemented during the manufacture of the floating particles so as to set up covalent bonds between the polymer constituting the particle and the flocculent polymer material and/or said other material.

Advantageously, the method will include a step of recycling the floating particles.

In this case, the method will advantageously comprise a step for cleaning the floating particles implemented before said recycling step. Such a step, which could be carried out according to various techniques known to those skilled in the art, for example by hydrocycloning, will be aimed at ridding the particles of the sludge agglomerated around them through the flocculent polymer material attached to these particles. In this case, the flocculent material will remain, in most cases, attached to the particles even in the case of a simple coating.

Through a method of this kind, the floating particles functionalized by the attachment to their surface of a flocculent material and as the case may be another material that is adsorbent and/or dedicated to specific pollution are put into contact with the liquid to be treated so as to obtain an optimal fixing of the pollution. The mixture obtained is sent to a flotation/separation zone where the floating particles meet together, at the surface taking with them at least one part of the pollution and where the treated water is collected at the bottom.

### DETAILED DESCRIPTION OF AN EMBODIMENT OF THE INVENTION

The invention as well as the various advantages that it presents will be understood more clearly from the following description of a non-exhaustive embodiment given by way of a reference to the single FIGURE.

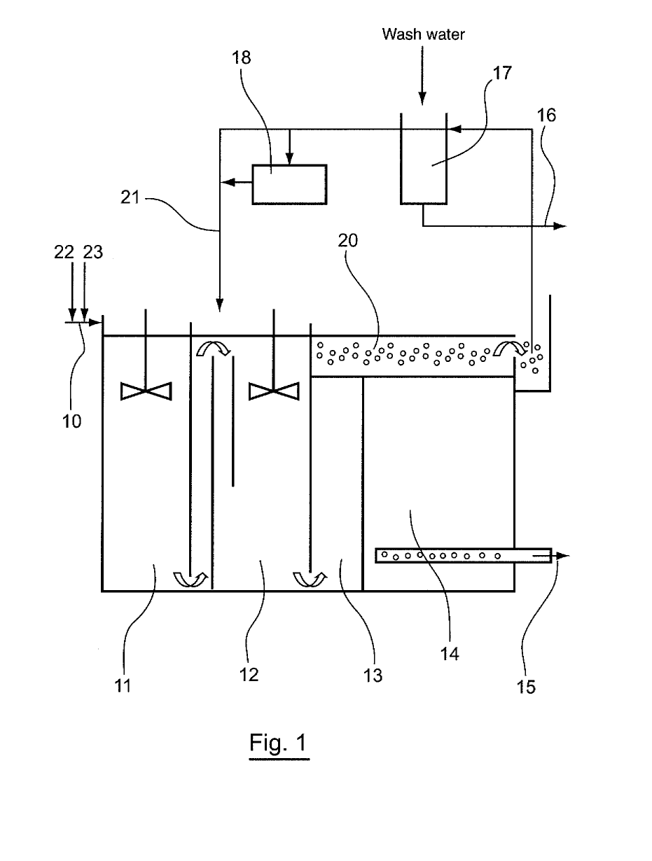

Referring to FIG. 1, an installation for implementing the method of the invention comprises:
a zone of coagulation under agitated or turbulent conditions (11) which could for example be created by an agitator or a static mixer;
an agitated mixing zone (12);
a flotation/separation zone (13/14) communicating with the mixing zone by an underflow and comprising means for extracting treated water (15) and floats (20);
a cleansing zone (17) which may for example be a highly agitated reactor or a water-injection cleaning apparatus (hydrocyclone, vibrating screen, centrifuge with perforated walls, highly agitated reactor or other separation apparatuses equipped with a system for injecting water at low flow rates to limit the dilution of the sludge);
a zone for regenerating (18) at least one part of the cleaned functionalized floating particles.

Referring to FIG. 1, the method according to the present invention consists in introducing raw water (10) into an agitated coagulation zone (11) in which a coagulant (22) has been pre-injected possibly with various other additives (23) such as activated carbon powder, resins or other similar elements that can be mixed into said particles to increase the efficiency of the treatment.

The flocculated water is then conveyed to a mixing zone (12) which for example may house a Turbomix®, an installation described in the patent application FR2863908 in which the floating particles coated on their surface with a flocculent polymer material are put into contact with the liquid to be treated so as to obtain an optimal fixing of the pollution. No free flocculent agent, i.e. an agent not attached to the floating particles, is introduced into the installation.

The mixture coming from this mixing zone is then introduced into a flotation/separation zone (13/14) by means of an underflow where it will spontaneously undergo a separation between the functionalized floating particles which rise to the surface within the flotation/separation zone (13/14) in carrying with them a part of the pollution initially contained in the water and the treated water at the bottom part of the flotation zone (13).

The water is extracted at the low part (15) while the floats, consisting of floating particles and the agglomerated sludge agglomerated on these particles that have remained on the surface are extracted at the top.

The floating particles (20) are sent into a cleaning zone (17) where they are washed of the sludge deposited on their surface. The washing of the floating particles may consist of an operation to place them in a highly agitated reactor or in a water-injection cleaning apparatuses and can be obtained by various methods (hydrocyclone, vibrating screen, centrifuge with perforated walls, highly agitated reactor or other separation apparatuses equipped with injection of water at low flow rates to restrict dilution of sludge).

The sludge (16) is extracted from the cleaning zone (17) and the floating particles are recycled (21) into a mixing zone (12). One part of these particles is regenerated (18) so that they recover their original properties.

Should additives be added without improving the efficiency of processing, said additives are also retrieved and recycled.

Trials have been conducted on Seine water with particles taking the form of polystyrene beads having diameters ranging between 500 and 800 μm coated with different hydrophilic flocculent polymers.

These particles were obtained by mixing polystyrene beads with a solution of hydrophilic flocculent polymer prepared at a concentration of 0.1 to 1 g/L.

The water to be treated (Seine water whose turbidity had been measured) is coagulated by the addition of a dose varying from 15 ppm to 60 ppm of a classic coagulant (WAC HB) under agitation in a small (2.5 L) Turbomix reactor provided with a flow guide and an agitator;
after one to two minutes of shaking, the polymer-coated floating particles were added to the Turbomix at the rate of less than 10% of the inner volume of the Turbomix and left in the recirculation stream for at least one minute without any addition of any free flocculent agents;
the turbidity of the water was measured, about ten seconds after the shaking was stopped.

A first series of trials were conducted without any addition of adsorbent material or material dedicated to treatment of a type of pollution given in free form.

The results obtained with the different types of polymers tested are presented in the following table 1:

TABLE 1

| WAC | | | | | | | |
|---|---|---|---|---|---|---|---|
| HB | Polymer | | | | Turbidity | | |
| Level | | | Molecular | Level | Raw | Treated | Reduction |
| (ppm) | Trade Name | Ionicity | Weight | (ppm) | Water | Water | (%) |
| 15 | FA920 | Non-ionic | High | 0.6 à | 40 | 4 | 90 |
| | | | | 25 | | | |
| 50 | AN905SEP | Very weak | High | 3 | 70 | 1.8 | 97 |
| | | ionic | | | | | |
| 30 | AN910VHM | Weak ionic | Very | 2 | 26 | 1.3 | 95 |
| | | | High | | | | |
| 30 | AN934SEP | Average | High | 2 | 26 | 3.5 | 87 |
| | | ionic | | | | | |
| 60 | AN956SEP | Strong | Haut | 2 | 85 | 32 | 62 |
| | | ionic | | | | | |
| 30 | FO4190VHM | Weak | Very | 1 | 31 | 0.64 | 98 |
| | | cationic | High | | | | |
| 30 | FO4190 | Weak | High | 2 | 31 | 0.7 | 98 |
| | | cationic | | | | | |
| 30 | FO4490 | Average | High | 2 | 31 | 2 | 94 |
| | | cationic | | | | | |
| 30 | FO4650 | Strong | Haut | 2 | 31 | 2.9 | 91 |
| | | cationic | | | | | |

Each of the polymers used was manufactured by SNF Floerger.

The results of the reduction of turbidity indicated in this table express the reduction of pollution, demonstrating the efficiency of the method according to the present invention especially when the flocculent polymer is constituted by a weak cationic or anionic polymer.

A second series of trials was then performed with a same apparatus following a protocol identical to the one described here above that active carbon was in addition used in introducing it at the same time as the coagulant.

The results obtained by implementing CAP doses commonly used in the treatment of water (10 ppm and 20 ppm) are presented in the following table 2:

| | | | Turbidity | | |
|---|---|---|---|---|---|
| WAC HB | CAP | FO4190 | Raw | Treated | |
| Level | Level | Level | Water | Water | Reduction |
| (ppm) | (ppm) | (ppm) | (NTU) | (NTU) | (%) |
| 30 | 10 | 2 | 19 | 0.54 | 97 |
| 30 | 20 | 2 | 19 | 0.57 | 97 |

According to these results, the turbidity values obtained (of the order 0.5 NTU) as well as the reduction yields (97%) of the turbidity confirm the efficiency of the method according to the invention in its variant coupling flotation with floating particles functionalized by a flocculent polymer with an adsorbent (CAP).

1-14. (canceled)

15. A method of treating water and removing suspended solids from the water by employing floating particles having at least some flocculant material attached thereto, the method comprising: placing the floating particles having the flocculant material thereon in the water to be treated at a depth below a surface level of the water; causing the particles having the polymer material to rise and move upwardly through the water wherein the process suspended solids in the water agglomerate on the particles; wherein the method is performed in the absence of adding gas or adding a free flocculant material unattached to the particles; and removing the floating particles having the agglomerated suspended solids from the water.

16. The method of claim 15 characterized in that the flocculant material is at least partially coated on the floating particles and comprises a flocculant polymer material.

17. The method of claim 15 wherein the floating particles include at least one material attached thereto other than the flocculant material.

18. The method of claim 16 wherein the flocculant polymer material coated onto the floating particles is a weak cationic or anionic polymer.

19. The method of claim 17 wherein the other material attached to the floating particles is an adsorbent material.

20. The method of claim 17 wherein the other material coated onto the floating particles is selected from a chemical or biological grouping intended to remove certain specific pollutants from the water being treated.

21. The method of claim 20 wherein the other material is taken from a chemical group and is selected from the group including hydroxyl, aldehyde, carbinyl, carboxyl, amino, amido, sulfhydryl, ester, phosphor, methyl and phenyl groupings.

22. The method of claim 20 wherein the other material is selected from a biological group and includes biological molecules selected from the group including polypeptides and nucleic acids.

23. The method of claim 15 wherein the floating particles include beads made of a polymer material.

24. The method of claim 23 wherein the floating particles are made from a polymer material chosen from the group including polystyrenes, polyurethanes, polyethylenes, and polyamides.

25. The method of claim 15 wherein the floating particles comprise polystyrene beads having a diameter of approximately 100 to approximately 1500 μm.

26. The method of claim 15 wherein the floating particles are hollow and made of a material selected from the group including glass, ceramics or metals.

27. The method of claim 15 wherein the floating particles comprise synthetic material and wherein the flocculant material is grafted or attached to the synthetic material.

28. The method of claim 15 including removing the floating particles from an upper portion of the water and removing at least some agglomerated suspended solids therefrom and thereafter recycling at least a portion of the floating particles.

29. The method of claim 15 including removing the floating particles from the water where at least some of the floating particles include suspended solids attached to the floating particles; cleaning the floating particles by removing at least some of the suspended solids from the floating particles; and returning cleaned floating particles to the water that is being treated.

30. A method of treating water and removing suspended solids therefrom utilizing floating particles that have attached thereto flocculant material, the method comprising:
directing the water to be treated into a zone and mixing a coagulant with the water;
mixing the floating particles having the flocculant material attached thereto with the water;
after mixing the coagulant agent with the water and mixing the floating particles with the water, directing the water and floating particles into a lower portion of a treatment zone;
from the lower portion of the treatment zone, causing the floating particles to rise upwardly through the water in the treatment zone;
as the floating particles rise upwardly through the treatment zone, the floating particles contact the suspended solids in the water and the suspended solids adhere or agglomerate on the floating particles;
wherein the floating particles continue to rise through the water in the treatment zone and reach the surface of the water or an upper portion of the water in the treatment zone; and
removing the floating particles from the water with the suspended solids attached or agglomerated thereon.

31. The method of claim 30 including:
after removing the floating particles from the water, directing the floating particles to a cleaning station where suspended solids are removed from the floating particles;
after removing the suspended solids adhered or agglomerated on the floating particles and cleaning the floating particles, recycling at least a portion of the floating particles to the water being treated.

32. The method of claim 31 including rejuvenating the cleaned floating particles by adhering or at least partially coating flocculate material onto the cleaned floating particles.

33. The method of claim 30 wherein the method is carried out in the absence of adding gas to the water and in the absence of adding a free flocculant material unattached to the floating particles.

34. The method of claim 30 wherein the method is carried out in a treatment system having at least three treatment zones, a first coagulation zone where a coagulate is mixed with the water, a mixing zone where the floating particles are mixed with the water; and the treatment zone which is disposed downstream of the mixing zone.

35. The method of claim 34 wherein the system includes a partition extending between the mixing and treatment zones and wherein the method includes directing the water and floating particles from the mixing zone, underneath the partition, and into the lower portion of the treatment zone where the floating particles rise upwardly through the water in the treatment zone.

36. The method of claim 30 wherein the floating particles comprise polystyrene beads having diameters ranging from approximately 500 μm to approximately 800 μm.

37. The method of claim 36 wherein the polystyrene beads are coated with a hydrophilic flocculant polymer.

38. The method of claim 30 wherein the floating particles include both a flocculant polymer material secured thereto and an adsorbent wherein both the flocculant material and adsorbent secured to the floating particles assist in removing suspended solids from the water being treated.
